(19) United States
(12) Patent Application Publication
(10) Pub. No.: US 2021/0377990 A1
(43) Pub. Date: Dec. 2, 2021

(54) Data Transmission Method and Data Transmission Apparatus

(71) Applicant: Huawei Technologies Co., Ltd., Shenzhen (CN)

(72) Inventors: Zheng Yu, Beijing (CN); Wenping Bi, Shenzhen (CN)

(21) Appl. No.: 17/401,588

(22) Filed: Aug. 13, 2021

Related U.S. Application Data
(63) Continuation of application No. PCT/CN2019/075266, filed on Feb. 15, 2019.

(51) Int. Cl. H04W 72/12; H04L 1/18

(52) U.S. Cl. CPC H04W 72/1278; H04L 1/1819; H04W 72/1263

(57) ABSTRACT

A data transmission method, including a first communications device receives control information sent by a second communications device, where the control information is used to schedule L transport blocks, M transport blocks in the L transport blocks scheduled by using the control information are retransmitted, and M is a value in a first value set, or H transport blocks in the L transport blocks scheduled by using the control information are retransmitted, and H is a value in a second value set associated with the quantity L of transport blocks, or L HARQ process indexes corresponding to the L transport blocks are consecutive, and the first communications device determines, based on the control information, whether the transport blocks scheduled by using the control information are newly transmitted or retransmitted, and sends or receives the transport blocks based on the scheduling with the control information.

### CROSS-REFERENCE TO RELATED APPLICATIONS

This application is a continuation of International Application No. PCT/CN2019/075266, filed on Feb. 15, 2019, the disclosure of which is hereby incorporated by reference in its entirety.

### TECHNICAL FIELD

This application relates to the communications field, and more specifically, to a data transmission method and a data transmission apparatus.

### BACKGROUND

In a communications system, one piece of downlink control information (DCI) may usually be used to schedule one transport block (TB), or one piece of DCI may be used to schedule a transport block carried on one data channel. The data channel may be a physical downlink shared data channel (PDSCH) or a physical uplink data channel (PUSCH).

With continuous development of communications technologies, one piece of DCI may be used to schedule a plurality of transport blocks, or one piece of DCI may be used to schedule transport blocks carried on a plurality of data channels. However, in this case, more transmission resources are consumed. For example, when one piece of DCI is used to schedule a plurality of transport blocks, the DCI needs to simultaneously indicate a quantity of scheduled transport blocks, a hybrid automatic repeat request (hybrid automatic retransmission request, HARQ) process index (process number/process index) corresponding to each transport block, and a transmission status corresponding to each transport block. The transmission status herein may indicate that the transport block is newly transmitted or retransmitted.

Therefore, how to improve resource efficiency when one piece of DCI is used to schedule a plurality of transport blocks or transport blocks carried on a plurality of data channels becomes a problem that needs to be urgently resolved.

### SUMMARY

This application provides a data transmission method and a data transmission apparatus, to reduce overheads of control information and improve resource utilization.

According to a first aspect, a data transmission method is provided, including a first communications device receives control information sent by a second communications device, where the control information is used to schedule L transport blocks, and L is a positive integer greater than 1, M transport blocks in the L transport blocks scheduled by using the control information are retransmitted, M is a positive integer not greater than L, M is a value in a first value set, and the first value set is a predefined value set or a value set indicated by the second communications device, or H transport blocks in the L transport blocks scheduled by using the control information are retransmitted, H is an integer, H is a value in a second value set associated with the quantity L of transport blocks, and the second value set is a predefined value set or is a value set indicated by the second communications device, or the control information indicates that K transport blocks in the L transport blocks are retransmitted, K is an integer whose value range is {0, 1, 2, . . . , L}, each of the L transport blocks corresponds to one hybrid automatic repeat request (HARQ) process index, and L HARQ process indexes corresponding to the L transport blocks are consecutive, and the first communications device determines, based on the control information, whether the transport blocks scheduled by using the control information are newly transmitted or retransmitted, and sends or receives the transport blocks based on the scheduling with the control information.

According to the method in the embodiments of this application, a quantity of retransmitted TB blocks in a plurality of TB blocks scheduled by using the control information can be limited, so that a quantity of combinations of transport blocks and retransmitted blocks can be reduced, to reduce overheads of control information and improve resource utilization.

In some possible implementations, the first value set is {1}, {1, 2}, {0, 1}, {0, 1, 2}, or {0, 1, 2, 3}, or the first value set is {0, 1, L} or {0, 1, 2, L}, or the first value set is {1, 2, . . . , T}, or the first value set is {0, 1, 2, . . . , T}, or the first value set is {1, 2, . . . , T−1}, and T is a positive integer indicated by the second communications device.

In some possible implementations, when L belongs to a first transport block quantity set, the second value set includes H1 values, or when L belongs to a second transport block quantity set, the second value set includes H2 values, and H1 is a positive integer, H2 is a positive integer, H1 is not equal to H2, and the first transport block quantity set and the second transport block quantity set are different sets.

In some possible implementations, when the first transport block quantity set is {2, 3, 4, 5}, the second value set is {1}, {0, 1}, {0, 1, L}, {1, L}, or {0, 1, 2, L}, and/or when the second transport block quantity set is {6, 7, 8}, the second value set is {1, 2}, {0, 1, 2}, {0, 1, 2, L}, {1, 2, L}, or {0, 1, 2, 3, L}.

In some possible implementations, when L=2, L=3, L=4, or L=5, the second value set is {1}, {0, 1}, {0, 1, L}, {1, L}, or {0, 1, 2, L}, and/or when L=6, L=7, or L=8, the second value set is {1, 2}, {0, 1, 2}, {0, 1, 2, L}, {1, 2, L}, or {0, 1, 2, 3, L}.

In some possible implementations, the control information includes a first field, at least one of bit states of the first field indicates that the control information is used to schedule a single transport block (TB), and at least one of bit states of the first field indicates that the control information is used for first scheduling, where the first scheduling indicates that the control information is used to schedule a plurality of transport blocks, and the control information can be used to schedule a part of newly transmitted TBs and a part of retransmitted TBs.

In some possible implementations, the first field indicates that the control information is used to schedule a single newly transmitted TB, and the first field indicates a hybrid automatic repeat request (HARQ) process index of the TB, or the first field indicates that the control information is used to schedule a single retransmitted TB, and the first field indicates a hybrid automatic repeat request (HARQ) process index of the TB.

In some possible implementations, at least a first transport block in a plurality of transport blocks scheduled by using the control information is retransmitted, or an L^{th} transport block in a plurality of transport blocks scheduled by using the control information is retransmitted, or at least a first transport block in a plurality of transport blocks scheduled by using the control information is retransmitted, and an L^{th} transport block in the plurality of transport blocks scheduled by using the control information is retransmitted.

In some possible implementations, a HARQ process index of another transport block different from the first transport block in the L transport blocks scheduled by using the control information is determined based on a HARQ process index of the first transport block, and/or each of the L transport blocks scheduled by using the control information corresponds to one HARQ process index, and the L HARQ process indexes corresponding to the L transport blocks are consecutive.

In some possible implementations, when the quantity of the transport blocks scheduled by using the control information is greater than X, the HARQ process index of the first transport block in the plurality of transport blocks scheduled by using the control information is 0, or the HARQ process index of the first transport block is a preset value, or the HARQ process index of the first transport block is a fixed value, where X is a preset positive integer, or X is a configured positive integer.

According to a second aspect, a data transmission method is provided, including a second communications device generates control information, where the control information is used to schedule L transport blocks, and L is a positive integer greater than 1, M transport blocks in the L transport blocks scheduled by using the control information are retransmitted, M is a positive integer not greater than L, M is a value in a first value set, and the first value set is a predefined value set or the first value set is a value set indicated by the second communications device, or H transport blocks in the L transport blocks scheduled by using the control information are retransmitted, H is an integer, H is a value in a second value set associated with the quantity L of transport blocks, and the second value set is a predefined value set or the second value set is a value set indicated by the second communications device, or the control information indicates that K transport blocks in the L transport blocks are retransmitted, K is an integer whose value range is {0, 1, 2, . . . , L}, each of the L transport blocks corresponds to one hybrid automatic repeat request (HARQ) process index, and L HARQ process indexes corresponding to the L transport blocks are consecutive, and the second communications device sends the control information to a first communications device.

According to the method in the embodiments of this application, a quantity of retransmitted TB blocks in a plurality of TB blocks scheduled by using the control information can be limited, so that a quantity of combinations of transport blocks and retransmitted blocks can be reduced, to reduce overheads of control information and improve resource utilization.

In some possible implementations, the first value set is {1}, {1, 2}, {0, 1}, {0, 1, 2}, or {0, 1, 2, 3}, or the first value set is {0, 1, L} or {0, 1, 2, L}, or the first value set is {1, 2, . . . , T}, or the first value set is {0, 1, 2, . . . , T}, or the first value set is {1, 2, . . . , T−1}, and T is a positive integer indicated by the second communications device.

In some possible implementations, when L belongs to a first transport block quantity set, the second value set includes H1 values, or when L belongs to a second transport block quantity set, the second value set includes H2 values, and H1 is a positive integer, H2 is a positive integer, H1 is not equal to H2, and the first transport block quantity set and the second transport block quantity set are different sets.

In some possible implementations, when the first transport block quantity set is {2, 3, 4, 5}, the second value set is {1}, {0, 1}, {0, 1, L}, {1, L}, or {0, 1, 2, L}, and/or when the second transport block quantity set is {6, 7, 8}, the second value set is {1, 2}, {0, 1, 2}, {0, 1, 2, L}, {1, 2, L}, or {0, 1, 2, 3, L}.

In some possible implementations, when L=2, L=3, L=4, or L=5, the second value set is {1}, {0, 1}, {0, 1, L}, {1, L}, or {0, 1, 2, L}, and/or when L=6, L=7, or L=8, the second value set is {1, 2}, {0, 1, 2}, {0, 1, 2, L}, {1, 2, L}, or {0, 1, 2, 3, L}.

In some possible implementations, the control information includes a first field, at least one of bit states of the first field indicates that the control information is used to schedule a single transport block (TB), and at least one of bit states of the first field indicates that the control information is used for first scheduling, where the first scheduling indicates that the control information is used to schedule a plurality of transport blocks, and the control information can be used to schedule a part of newly transmitted TBs and a part of retransmitted TBs.

In some possible implementations, the first field indicates that the control information is used to schedule a single newly transmitted TB, and the first field indicates a hybrid automatic repeat request (HARQ) process index of the TB, or the first field indicates that the control information is used to schedule a single retransmitted TB, and the first field indicates a hybrid automatic repeat request (HARQ) process index of the TB.

In some possible implementations, at least a first transport block in a plurality of transport blocks scheduled by using the control information is retransmitted, or an L^{th} transport block in a plurality of transport blocks scheduled by using the control information is retransmitted, or at least a first transport block in a plurality of transport blocks scheduled by using the control information is retransmitted, and an L^{th} transport block in the plurality of transport blocks scheduled by using the control information is retransmitted.

In some possible implementations, a HARQ process index of another transport block different from the first transport block in the L transport blocks scheduled by using the control information is determined based on a HARQ process index of the first transport block, and/or each of the L transport blocks scheduled by using the control information corresponds to one HARQ process index, and the L HARQ process indexes corresponding to the L transport blocks are consecutive.

In some possible implementations, when the quantity of the transport blocks scheduled by using the control information is greater than X, the HARQ process index of the first transport block in the plurality of transport blocks scheduled by using the control information is 0, or the HARQ process index of the first transport block is a preset value, or the HARQ process index of the first transport block is a fixed value, where X is a preset positive integer, or X is a configured positive integer.

According to a third aspect, a data transmission method is provided, including a terminal device receives first downlink control information (DCI) sent by a network device, where the first DCI is used to schedule M transport blocks, the M transport blocks include L retransmitted blocks, both M and L are integers, and a value range of L is a proper subset of [0, M], and the terminal device determines a quantity of transport blocks and a quantity of retransmitted blocks based on the first DCI.

According to the method in the embodiments of this application, the first DCI is used to schedule L transport blocks, the L transport blocks include M retransmitted blocks, and a value range of M is a proper subset of [0, L]. This can reduce a quantity of combinations of transport blocks and retransmitted blocks, and can limit a quantity of retransmitted TB blocks in a plurality of TB blocks scheduled once, thereby helping reduce overheads of control information and improve resource utilization.

The M retransmitted blocks may be understood as retransmitted transport blocks in the L transport blocks. Alternatively, the M retransmitted blocks may be understood as incorrect transport blocks in the L transport blocks. L may be an integer greater than or equal to 1 and less than or equal to N, and N is a maximum quantity of TB blocks that can be scheduled by using one piece of DCI. For example, for CEModeA, N may be 8, and for CEModeB, N may be 4.

It should be understood that the value range of M is the proper subset of [0, L], to be specific, for the L transport blocks scheduled by using the first DCI, the quantity M of retransmitted blocks is supported to be only a part of [0, L]. Another unsupported quantity M of retransmitted blocks may be scheduled and indicated with reference to the conventional technology. Details are not described in the embodiments of this application.

To be specific, at least one L within [1, N] meets the following condition, where the first DCI is used to schedule L transport blocks, the L transport blocks include M retransmitted blocks, and in this case, the value range of M is a proper subset of [0, L].

In some possible implementations, when M is 2, the value range of L is {0, 1}, and/or when M belongs to {3, 4, 5}, the value range of L is {0, 1, 2, M}, and/or when M belongs to {6, 7, 8}, the value range of L is {0, 1, 2, 3, M}.

In some possible implementations, the value range of L is [1, M] or [2, M].

In some possible implementations, the first DCI further includes at least one of M hybrid automatic repeat request (HARQ) process indexes corresponding to the M transport blocks, and the M HARQ process indexes are consecutive.

Optionally, the at least one HARQ process index may be predefined, or the at least one HARQ process index may be notified by higher layer signaling, or the at least one HARQ process index may be indicated by DCI.

For example, the first DCI may include one of the M HARQ process indexes corresponding to the M transport blocks. In this case, if the M HARQ process indexes are consecutive, after the terminal device receives the first DCI, the terminal device can determine other M−1 HARQ process indexes based on the HARQ process index. That the M HARQ process indexes are consecutive may indicate that the M HARQ process indexes are continuously increasing, or may indicate that the M HARQ process indexes are continuously decreasing.

In some possible implementations, that the terminal device determines transport blocks and retransmitted blocks based on the first DCI includes the terminal device determines the transport blocks and the retransmitted blocks based on a formula Σᵢ₌₁^{M-1}(N−i+1)*2ⁱ+HARQₛₜₐᵣₜ*2^{M}+k and the first DCI, where N represents a total quantity of HARQ processes, M represents a quantity of transport blocks, HARQₛₜₐᵣₜ represents a smallest one of the M HARQ process indexes, and k=2^{NDIM*(M-1)}+2^{NDI(M-1)*(M-2)}+ . . . +NDI1, where NDIM indicates that an M^{th} TB is initially transmitted or retransmitted, if the M^{th} TB is initially transmitted, k is 0, otherwise, k is 1.

It should be understood that the first DCI may include a value. The value may correspond to a combination of transport blocks and retransmitted blocks. The terminal device may inversely calculate, by using the foregoing formula and by using the value, a combination of transport blocks and retransmitted blocks corresponding to the data, that is, the first DCI is used to schedule M transport blocks, and the M transport blocks include L retransmitted blocks.

Alternatively, the value may indicate at least one of the M HARQ process indexes corresponding to the M transport blocks.

In another possible implementation, the terminal device may prestore a table. The table may include all possible combinations of transport blocks and retransmitted blocks, and each entry in the table (that is, each combination of transport blocks and retransmitted blocks) may correspond to an index value. It should be understood that the table may be determined based on value ranges of M and L.

Optionally, the first DCI may include an index value. The index value may correspond to a combination of transport blocks and retransmitted blocks. The terminal device searches for an entry corresponding to the index value, to determine the combination of the transport blocks and the retransmitted blocks indicated by the index value. In other words, the index value may be used to indicate that the first DCI is used to schedule M transport blocks, and the M transport blocks include L retransmitted blocks.

Alternatively, the index value may indicate at least one of the M HARQ process indexes corresponding to the M transport blocks.

Optionally, the table may be preconfigured, or the table may be configured by a higher layer, or the table may be specified in a protocol. This is not limited in the embodiments of this application.

According to a fourth aspect, a data transmission method is provided, including a network device generates first downlink control information (DCI), where the first DCI is used to schedule L transport blocks, the M transport blocks include M retransmitted blocks, both M and L are integers, and a value range of M is a proper subset of [0, L], and the network device sends the first DCI to a terminal device.

According to the method in the embodiments of this application, the first DCI is used to schedule L transport blocks, the M transport blocks include M retransmitted blocks, and the value range of M is a proper subset of [0, L]. This can reduce a quantity of combinations of transport blocks and retransmitted blocks, and can limit a quantity of retransmitted TB blocks in a plurality of TB blocks scheduled once, thereby helping reduce overheads of control information and improve resource utilization.

The M retransmitted blocks may be understood as retransmitted transport blocks in the L transport blocks. Alternatively, the M retransmitted blocks may be understood as incorrect transport blocks in the L transport blocks. L may be an integer greater than or equal to 1 and less than or equal to N, and N is a maximum quantity of TB blocks that can be scheduled by using one piece of DCI. For example, for CEModeA, N may be 8, and for CEModeB, N may be 4.

It should be understood that the value range of M is the proper subset of [0, L], to be specific, for the L transport blocks scheduled by using the first DCI, the quantity M of retransmitted blocks is supported to be only a part of [0, L]. Another unsupported quantity M of retransmitted blocks may be scheduled and indicated with reference to the conventional technology. Details are not described in the embodiments of this application.

To be specific, at least one L within [1, N] meets the following condition, where the first DCI is used to schedule L transport blocks, the L transport blocks include M retransmitted blocks, and in this case, the value range of M is a proper subset of [0, L].

In some possible implementations, when M is 2, the value range of L is {0, 1}, and/or when M belongs to {3, 4, 5}, the value range of L is {0, 1, 2, M}, and/or when M belongs to {6, 7, 8}, the value range of L is {0, 1, 2, 3, M}.

In some possible implementations, the value range of L is [1, M] or [2, M].

In some possible implementations, the first DCI further includes at least one of M hybrid automatic repeat request (HARQ) process indexes corresponding to the M transport blocks, and the M HARQ process indexes are consecutive.

Optionally, the at least one HARQ process index may be predefined, or the at least one HARQ process index may be notified by higher layer signaling, or the at least one HARQ process index may be indicated by DCI.

For example, the first DCI may include one of the M HARQ process indexes corresponding to the M transport blocks. In this case, if the M HARQ process indexes are consecutive, after the terminal device receives the first DCI, the terminal device can determine other M−1 HARQ process indexes based on the HARQ process index. That the M HARQ process indexes are consecutive may indicate that the M HARQ process indexes are continuously increasing, or may indicate that the M HARQ process indexes are continuously decreasing.

In some possible implementations, that the network device generates the first DCI includes the network device generates the first DCI according to a formula Σᵢ₌₁^{M-1}(N−i+1)*2ⁱ+HARQₛₜₐᵣₜ*2^{M}+k, where N represents a total quantity of HARQ processes, M represents a quantity of transport blocks, HARQₛₜₐᵣₜ represents a smallest one of the M HARQ process indexes, and k=2^{NDIM*(M-1)}+2^{NDI(M-1)*(M-2)}+ . . . +NDI1, where NDIM indicates that an M^{th} TB is initially transmitted or retransmitted, if the M^{th} TB is initially transmitted, k is 0, otherwise, k is 1.

Optionally, the first DCI may be used to indicate the transport blocks and the retransmitted blocks.

Optionally, the first DCI may include a value calculated by using the foregoing formula. The data may correspond to a combination of transport blocks and retransmitted blocks. In other words, the value may be used to indicate that the first DCI is used to schedule M transport blocks, and the M transport blocks include L retransmitted blocks.

Alternatively, the value may indicate at least one of the M HARQ process indexes corresponding to the M transport blocks.

Alternatively, the network device may prestore a table. The table may include all possible combinations of transport blocks and retransmitted blocks, and each entry in the table (that is, each combination of transport blocks and retransmitted blocks) may correspond to an index value. It should be understood that the table may be determined based on value ranges of M and L.

Optionally, the first DCI may include one index value in the table. The index value may be used to indicate that the first DCI is used to schedule M transport blocks, and the M transport blocks include L retransmitted blocks.

Alternatively, the index value may indicate at least one of the M HARQ process indexes corresponding to the M transport blocks.

Optionally, the table may be preconfigured, or the table may be configured by a higher layer, or the table may be specified in a protocol. This is not limited in the embodiments of this application.

According to a fifth aspect, a data transmission apparatus is provided, and is configured to perform the method in the first aspect or any possible implementation of the first aspect. Specifically, the apparatus includes modules configured to perform the method in the first aspect or any possible implementation of the first aspect.

According to a sixth aspect, a data transmission apparatus is provided, and is configured to perform the method in the second aspect or any possible implementation of the second aspect. Specifically, the apparatus includes modules configured to perform the method in the second aspect or any possible implementation of the second aspect.

According to a seventh aspect, a data transmission apparatus is provided, and is configured to perform the method in the third aspect or any possible implementation of the third aspect. Specifically, the apparatus includes modules configured to perform the method in the third aspect or any possible implementation of the third aspect.

According to an eighth aspect, a data transmission apparatus is provided, and is configured to perform the method in the fourth aspect or any possible implementation of the fourth aspect. Specifically, the apparatus includes modules configured to perform the method in the fourth aspect or any possible implementation of the fourth aspect.

According to a ninth aspect, a data transmission apparatus is provided. The apparatus includes a transceiver and a processor. The processor is configured to invoke instructions from a memory and run the instructions stored in the memory, to perform the method in the first aspect or any possible implementation of the first aspect.

Optionally, the data transmission apparatus further includes the memory, and the memory is configured to store the instructions.

Optionally, there are one or more processors, and there are one or more memories.

In a specific implementation process, the memory may be a non-transitory memory, for example, a read-only memory (ROM). The memory and the processor may be integrated on a same chip, or may be disposed separately. A type of the memory and a manner of disposing the memory and the processor are not limited in the embodiments of this application.

According to a tenth aspect, a data transmission apparatus is provided. The apparatus includes a transceiver and a processor. The processor is configured to invoke instructions from a memory and run the instructions stored in the memory, to perform the method in the second aspect or any possible implementation of the second aspect.

Optionally, the data transmission apparatus further includes the memory, and the memory is configured to store the instructions.

Optionally, there are one or more processors, and there are one or more memories.

In a specific implementation process, the memory may be a non-transitory memory, for example, a read-only memory (ROM). The memory and the processor may be integrated on a same chip, or may be disposed separately. A type of the memory and a manner of disposing the memory and the processor are not limited in the embodiments of this application.

According to an eleventh aspect, a data transmission apparatus is provided. The apparatus includes a transceiver and a processor. The processor is configured to invoke instructions from a memory and run the instructions stored in the memory, to perform the method in the third aspect or any possible implementation of the third aspect.

Optionally, the data transmission apparatus further includes the memory, and the memory is configured to store the instructions.

Optionally, there are one or more processors, and there are one or more memories.

In a specific implementation process, the memory may be a non-transitory memory, for example, a read-only memory (ROM). The memory and the processor may be integrated on a same chip, or may be disposed separately. A type of the memory and a manner of disposing the memory and the processor are not limited in the embodiments of this application.

According to a twelfth aspect, a data transmission apparatus is provided. The apparatus includes a transceiver and a processor. The processor is configured to invoke instructions from a memory and run the instructions stored in the memory, to perform the method in the fourth aspect or any possible implementation of the fourth aspect.

Optionally, the data transmission apparatus further includes the memory, and the memory is configured to store the instructions.

Optionally, there are one or more processors, and there are one or more memories.

In a specific implementation process, the memory may be a non-transitory memory, for example, a read-only memory (ROM). The memory and the processor may be integrated on a same chip, or may be disposed separately. A type of the memory and a manner of disposing the memory and the processor are not limited in the embodiments of this application.

According to a thirteenth aspect, a computer program product is provided. The computer program product includes computer program code, and when the computer program code is run on a computer, the computer is enabled to perform the methods in the foregoing aspects.

According to a fourteenth aspect, a computer-readable medium is provided, and is configured to store a computer program. The computer program includes instructions used to perform the methods in the foregoing aspects.

According to the method in the embodiments of this application, a quantity of retransmitted TB blocks in a plurality of TB blocks scheduled by using control information can be limited, so that a quantity of combinations of transport blocks and retransmitted blocks can be reduced, to reduce overheads of control information and improve resource utilization.

### BRIEF DESCRIPTION OF THE DRAWINGS

FIG. 1 is a schematic architectural diagram of a communications system applicable to an embodiment of this application;

FIG. 2 is a schematic flowchart of a data transmission method according to an embodiment of this application;

FIG. 3 is a schematic structural diagram of a data transmission apparatus according to an embodiment of this application;

FIG. 4 is a schematic structural diagram of a data transmission apparatus according to another embodiment of this application; and

FIG. 5 is a schematic structural diagram of a data transmission apparatus according to another embodiment of this application; and

### DETAILED DESCRIPTION OF ILLUSTRATIVE EMBODIMENTS

The following describes technical solutions of this application with reference to accompanying drawings.

The technical solutions of the embodiments of this application may be applied to various communications systems, such as a global system for mobile communications (GSM), a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD), a universal mobile telecommunications system (UMTS), a worldwide interoperability for microwave access (WiMAX) communications system, a future 5^{th} generation (5G) system, or a new radio (NR) system.

A terminal device in the embodiments of this application may be user equipment, an access terminal, a subscriber unit, a subscriber station, a mobile station, a mobile console, a remote station, a remote terminal, a mobile device, a user terminal, a terminal, a wireless communications device, a user agent, a user apparatus, or the like. The terminal device may alternatively be a cellular phone, a cordless phone, a session initiation protocol (SIP) phone, a wireless local loop (WLL) station, a personal digital assistant (PDA), a handheld device having a wireless communications function, a computing device, another processing device connected to a wireless modem, a vehicle-mounted device, a wearable device, a terminal device in a future 5G network, a terminal device in a future evolved public land mobile network (PLMN), or the like. This is not limited in the embodiments of this application.

As an example rather than a limitation, in the embodiments of this application, the terminal device may alternatively be a wearable device. A wearable device may also be referred to as a wearable intelligent device, and is a general term for wearable devices such as glasses, gloves, watches, clothes, and shoes that are developed by applying wearable technologies in intelligent designs of daily wear. A wearable device is a portable device that can be directly worn on a body or integrated into clothes or an accessory of a user. A wearable device is not merely a hardware device, but is used to implement a powerful function through software support, data interaction, and cloud interaction. Generalized wearable intelligent devices include full-featured and large-size devices, such as smart watches or smart glasses, that can implement all or partial functions without depending on smartphones, and devices, such as various smart bands, or smart jewelry for monitoring physical signs, that focus on only one type of application functions and need to work with other devices such as smartphones.

In addition, the terminal device in the embodiments of this application may alternatively be a terminal device in an internet of things (IoT) system. IoT is an important part of development of future information technologies. A main technical feature of the IoT is to connect an object to a network through a communications technology, to implement an intelligent network of human-machine interconnection and thing-thing interconnection. In the embodiments of this application, massive connections, deep coverage, and terminal power saving may be implemented by using, for example, a narrowband (NB) technology in an IoT technology.

In addition, in the embodiments of this application, the terminal device may further include sensors such as a smart printer, a train detector, and a gas station. Main functions include collecting data (some terminal devices), receiving control information and downlink data of a network device, sending an electromagnetic wave, and transmitting uplink data to the network device.

The network device in the embodiments of this application may be a device configured to communicate with the terminal device. The network device may be a base transceiver station (BTS) in a global system for mobile communications (GSM) or a code division multiple access (CDMA) system, may be a NodeB (NB) in a wideband code division multiple access (wideband code division multiple access, WCDMA) system, may be an evolved NodeB (evolved NodeB, eNB or eNodeB) in an LTE system, or may be a radio controller in a cloud radio access network (CRAN) scenario. Alternatively, the network device may be a relay node, an access point, a vehicle-mounted device, a wearable device, a network device in a future 5G network, a network device in a future evolved PLMN, or the like. This is not limited in the embodiments of this application.

It should be understood that the technical solutions provided in this application may be applied to various communications systems such as a 5G mobile communications system. The 5G mobile communications system in this application includes a non-standalone (NSA) 5G mobile communications system and/or a standalone (SA) 5G mobile communications system. The technical solutions provided in this application may be further applied to a future communications system such as a sixth generation mobile communications system.

In the embodiments of this application, the terminal device or the network device includes a hardware layer, an operating system layer running on the hardware layer, and an application layer running on the operating system layer. The hardware layer includes hardware such as a central processing unit (CPU), a memory management unit (MMU), and a memory (also referred to as a main memory). The operating system may be any one or more computer operating systems, for example, a Linux operating system, a Unix operating system, an Android operating system, an iOS operating system, or a Windows operating system, that implement service processing by using a process. The application layer includes applications such as a browser, contacts, word processing software, and instant communications software. In addition, a specific structure of an execution body of a method provided in the embodiments of this application is not specifically limited in the embodiments of this application, provided that a program that records code of the method provided in the embodiments of this application can be run to perform communications according to the method provided in the embodiments of this application. For example, the execution body of the method provided in the embodiments of this application may be the terminal device or the network device, or a function module that can invoke and execute the program in the terminal device or the network device.

In addition, aspects or features of this application may be implemented as a method, an apparatus or a product that uses standard programming and/or engineering technologies. The term “product” used in this application covers a computer program that can be accessed from any computer-readable component, carrier or medium. For example, a computer-readable medium may include but is not limited to, a magnetic storage component (for example, a hard disk, a floppy disk, or a magnetic tape), an optical disc (for example, a compact disc (CD) or a digital versatile disc (DVD)), a smart card, and a flash memory component (for example, an erasable programmable read-only memory (EPROM), a card, a stick, or a key drive). In addition, various storage media described in this specification may represent one or more devices and/or other machine-readable media that are configured to store information. The term “machine-readable media” may include but is not limited to a radio channel, and various other media that can store, contain, and/or carry instructions and/or data.

It should be understood that, in the embodiments of this application, a first communications device may be a terminal device in a communications system, and a second communications device may be a network device in the communications system.

FIG. 1 is a schematic diagram of a communications system 100 applicable to an embodiment of this application. A method in this embodiment of this application may be applied to the communications system 100 shown in FIG. 1. It should be understood that the communications system 100 to which the method in the embodiments of this application may be applied may include more or fewer network devices or terminal devices.

A network device or a terminal device in FIG. 1 may be hardware, or may be software obtained through functional division, or a combination thereof. The network device and the terminal device in FIG. 1 may communicate with each other by using another device or network element.

In the communications system 100 shown in FIG. 1, a network device 110 and terminal devices 101 to 106 form the communications system 100. In the communications system 100, the network device 110 may send control information and/or transport blocks to the terminal devices 101 to 106. Certainly, the terminal devices 101 to 106 may also send uplink data to the network device 110. It should be understood that each of the terminal devices 101 to 106 may be, for example, a cellular phone, a smartphone, a portable computer, a handheld communications device, a handheld computing device, a satellite radio apparatus, a global positioning system, a PDA, and/or any other appropriate device used for communications in the wireless communications system 100.

The communications system 100 may be a PLMN network, a device-to-device (D2D) network, a machine to machine (M2M) network, an IoT network, or another network.

In addition, the terminal devices 104 to 106 may form a communications system. In the communications system, the terminal device 105 may send control information and/or transport blocks to the terminal device 104 or the terminal device 106. Correspondingly, the terminal device 104 or the terminal device 106 may also send uplink data to the terminal device 105.

In this embodiment of this application, the control information may be used to schedule a plurality of transport blocks (transmission block, TB). In this case, usually a relatively large amount of service data needs to be continuously transmitted for a relatively long period of time. Therefore, within a relatively long period of time thereafter, a quantity of scheduled TB blocks is correspondingly stable, and does not change greatly. In addition, when the communications system schedules the TB blocks for transmission, it is ensured that a failure probability of transport blocks is less than a specific proportion, to achieve specific transmission efficiency. For example, a current communications system usually ensures that a block error rate (BLER) is less than 1000. Correspondingly, a probability of incorrect K TB blocks when L TB blocks are scheduled can be calculated based on the block error rate. Details are shown in the following Table 1 to Table 7, where both L and K are integers.

TABLE 1
Probability of incorrect K TB blocks when eight TBs are scheduled

| Quantity of | Quantity of | | Total |
|---|---|---|---|
| incorrect TBs | combinations | Probability | probability |
| 0 | 1 | 43% | 96.14% |
| 1 | 8 | 38.26% | |
| 2 | 28 | 14.88% | |
| 3 | 56 | 3.3% | |
| 4 | 20 | 0.4 | |

TABLE 2
Probability of incorrect K TB blocks when seven TBs are scheduled

| Quantity of | Quantity of | | Total |
|---|---|---|---|
| incorrect TBs | combinations | Probability | probability |
| 0 | 1 | 47.8% | 97.4% |
| 1 | 7 | 37.2% | |
| 2 | 21 | 12.4% | |
| 3 | 35 | 2.29% | |

TABLE 3
Probability of incorrect K TB blocks when six TBs are scheduled

| Quantity of | Quantity of | | Total |
|---|---|---|---|
| incorrect TBs | combinations | Probability | probability |
| 0 | 1 | 53.1% | 98.3% |
| 1 | 6 | 35.14% | |
| 2 | 15 | 9.8% | |
| 3 | 20 | 1.45% | |

TABLE 4
Probability of incorrect K TB blocks when five TBs are scheduled

| Quantity of | Quantity of | | Total |
|---|---|---|---|
| incorrect TBs | combinations | Probability | probability |
| 0 | 1 | 59% | 99.09% |
| 1 | 5 | 32.8% | |
| 2 | 10 | 7.29% | |
| 3 | | | |

TABLE 5
Probability of incorrect K TB blocks when four TBs are scheduled

| Quantity of | Quantity of | | Total |
|---|---|---|---|
| incorrect TBs | combinations | Probability | probability |
| 0 | 1 | 65.6% | 94.7% |
| 1 | 4 | 29.1% | |
| 2 | 6 | 4.8% | |
| 3 | | | |

TABLE 6
Probability of incorrect K TB blocks when three TBs are scheduled

| Quantity of | Quantity of | | Total |
|---|---|---|---|
| incorrect TBs | combinations | Probability | probability |
| 0 | 1 | 72.9% | 97.2% |
| 1 | 3 | 24.3% | |
| 2 | 3 | | |
| 3 | | | |

TABLE 7
Probability of incorrect K TB blocks when two TBs are scheduled

| Quantity of | Quantity of | | Total |
|---|---|---|---|
| incorrect TBs | combinations | Probability | probability |
| 0 | 1 | 81% | 99% |
| 1 | 2 | 18% | |
| 2 | 1 | | |
| 3 | | | |

It can be learned from the probabilities of incorrect K TB blocks when L TB blocks are scheduled in the foregoing tables that, when the control information is used to schedule a plurality of TB blocks, a probability of incorrect one or two TB blocks has exceeded 96%.

Therefore, this application provides a data transmission method, to limit a quantity of retransmitted TB blocks in a plurality of TB blocks scheduled once. This reduces a quantity of combinations of transport blocks and retransmitted blocks, to reduce overheads of control information and improve resource utilization.

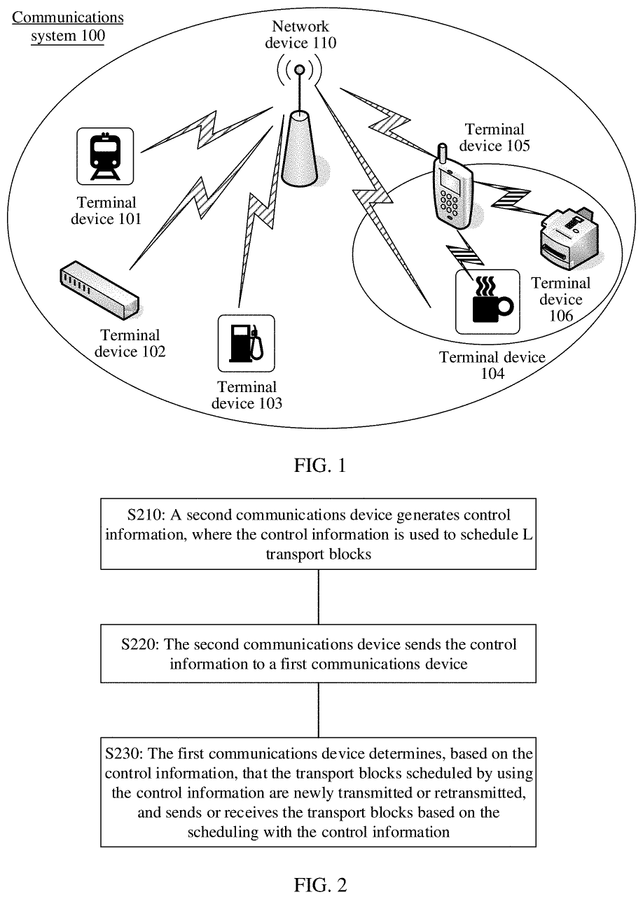

FIG. 2 is a schematic flowchart of a data transmission method 200 according to an embodiment of this application. A first communications device in the method shown in FIG. 2 may correspond to the terminal device in the communications system 100 shown in FIG. 1, and a second communications device may correspond to the network device in the communications system 100 shown in FIG. 1.

It should be understood that FIG. 2 shows steps or operations of the method 200. However, these steps or operations are merely examples. In this embodiment of this application, other operations or variations of the operations in FIG. 2 may be further performed, or not all steps need to be performed. Alternatively, these steps may be performed in other orders.

S210: The second communications device generates control information. The control information is used to schedule L transport blocks, and L is a positive integer greater than 1.

S220: The second communications device sends the control information to a first communications device.

S230: The first communications device determines, based on the control information, whether the transport blocks scheduled by using the control information are newly transmitted or retransmitted, and sends or receives the transport blocks based on the scheduling with the control information.

In this embodiment of this application, the control information may be downlink control information (downlink control information, DCI).

In a possible implementation, M transport blocks in the L transport blocks scheduled by using the control information may be retransmitted, M is a positive integer not greater than L, M is a value in a first value set, and the first value set may be a predefined value set or the first value set may be a value set indicated by the second communications device.

Optionally, the first value set may be {1}, {1, 2}, {0, 1}, {0, 1, 2}, or {0, 1, 2, 3}; or the first value set may be {0, 1, L} or {0, 1, 2, L}, or the first value set may be {1, 2, . . . , T}, or the first value set may be {0, 1, 2, . . . , T}, or the first value set may be {1, 2, . . . , T−1}, and T is a positive integer indicated by the second communications device.

Specifically, “o” in the first value set may indicate that all L transport blocks scheduled by using the control information are newly transmitted. “1” in the first value set may indicate that one transport block in the L transport blocks scheduled by using the control information is retransmitted, and all other transport blocks are newly transmitted. “L” in the first value set may indicate that all L transport blocks scheduled by using the control information are retransmitted. Meanings of other values in the first numerical set are similar, and details are not described herein again.

In another possible implementation, H transport blocks in the L transport blocks scheduled by using the control information may be retransmitted, H is an integer, H may be a value in a second value set associated with the quantity L of transport blocks, and the second value set may be a predefined value set or the second value set may be a value set indicated by the second communications device.

Optionally, when L belongs to a first transport block quantity set, the second value set may include H1 values, or when L belongs to a second transport block quantity set, the second value set may include H2 values, and H1 is a positive integer, H2 is a positive integer, H1 may not be equal to H2, and the first transport block quantity set and the second transport block quantity set may be different sets.

For example, when the first transport block quantity set is {2, 3, 4, 5}, the second value set may be {1}, {0, 1}, {0, 1, L}, {1, L}, or {0, 1, 2, L}, and/or when the second transport block quantity set is {6, 7, 8}, the second value set may be {1, 2}, {0, 1, 2}, {0, 1, 2, L}, {1, 2, L}, or {0, 1, 2, 3, L}. In this case, H1=4, H2=3, and the first transport block quantity set and the second transport block quantity set are different sets.

Alternatively, for example, when L=2, L=3, L=4, or L=5, the second value set may be {1}, {0, 1}, {0, 1, L}, {1, L}, or {0, 1, 2, L}, and/or when L=6, L=7, or L=8, the second value set may be {1, 2}, {0, 1, 2}, {0, 1, 2, L}, {1, 2, L}, or {0, 1, 2, 3, L}.

Similarly, “0” in the second value set may indicate that all L transport blocks scheduled by using the control information are newly transmitted. “1” in the second value set may indicate that one transport block in the L transport blocks scheduled by using the control information is retransmitted, and all other transport blocks are newly transmitted. “L” in the second value set may indicate that all L transport blocks scheduled by using the control information are retransmitted. Meanings of other values in the second numerical set are similar, and details are not described herein again.

In another possible implementation, the control information indicates that K transport blocks in the L transport blocks may be retransmitted, K is an integer whose value range is {0, 1, 2, . . . , L}, each of the L transport blocks may correspond to one hybrid automatic repeat request (HARQ) process index, and L HARQ process indexes corresponding to the L transport blocks may be consecutive.

Optionally, a HARQ process index of another transport block different from a first transport block in the L transport blocks scheduled by using the control information may be determined based on a HARQ process index of the first transport block.

For example, the control information may indicate the HARQ process index of the first transport block, and the L HARQ process indexes corresponding to the L transport blocks may be continuously increasing. In this case, the HARQ process index of the another transport block may be determined based on the HARQ process index of the first transport block.

Alternatively, the L HARQ process indexes corresponding to the L transport blocks may be continuously decreasing.

Optionally, each of the L transport blocks scheduled by using the control information may correspond to one HARQ process index, and the L HARQ process indexes corresponding to the L transport blocks may be consecutive.

Optionally, when the quantity of transport blocks scheduled by using the control information is greater than X, a HARQ process index of a first transport block in a plurality of transport blocks scheduled by using the control information may be 0, or a HARQ process index of a first transport block may be a preset value, or a HARQ process index of a first transport block may be a fixed value, where X is a preset positive integer, or X is a configured positive integer.

For example, X may be seven. In other words, when the quantity of transport blocks scheduled by using the control information is greater than seven, the HARQ process index of the first transport block in the plurality of transport blocks scheduled by using the control information may be 0. Alternatively, when the quantity of transport blocks scheduled by using the control information is greater than seven, the HARQ process index of the first transport block may be a preset value. Alternatively, when the quantity of transport blocks scheduled by using the control information is greater than seven, the HARQ process index of the first transport block may be a fixed value. It should be understood that, that X is seven herein is merely an example rather than a limitation, and X may alternatively be another value.

In this embodiment of this application, the control information may include a first field.

Specifically, at least one of bit states of the first field indicates that the control information is used to schedule a single transport block (TB), and at least one of bit states of the first field indicates that the control information is used for first scheduling, where the first scheduling indicates that the control information is used to schedule a plurality of transport blocks, and the control information can be used to schedule a part of newly transmitted TBs and a part of retransmitted TBs.

For example, the control information may include a 4-bit (bit) first field, and when a bit state of the first field is “0001”, it may be indicated that the control information is used to schedule one transport block (TB).

For another example, when a bit state of the first field is “0011”, it may be indicated that the control information is used for first scheduling, that is, the control information is used to schedule a plurality of transport blocks.

It should be understood that the foregoing bit state is merely an example rather than a limitation. In this embodiment of this application, another bit state in the bit states of the first field may also be used to indicate that the control information is used to schedule a single transport block (TB) or that the control information is used for first scheduling. This is not limited in this application.

Optionally, the first field may indicate that the control information is used to schedule a single newly transmitted TB, and the first field indicates a hybrid automatic repeat request (HARQ) process index of the TB, or the first field may indicate that the control information is used to schedule a single retransmitted TB, and the first field indicates a hybrid automatic repeat request (HARQ) process index of the TB.

In a possible implementation, at least a first transport block in a plurality of transport blocks scheduled by using the control information is retransmitted, or an L^{th} transport block in a plurality of transport blocks scheduled by using the control information is retransmitted, or at least a first transport block in a plurality of transport blocks scheduled by using the control information is retransmitted, and an L^{th} transport block in the plurality of transport blocks scheduled by using the control information is retransmitted.

According to the data transmission method in this embodiment of this application, a quantity of retransmitted TB blocks in a plurality of TB blocks scheduled by using the control information can be limited, so that a quantity of combinations of transport blocks and retransmitted blocks can be reduced, to reduce overheads of control information and improve resource utilization.

Further, it can be learned from the foregoing Table 1 to Table 7 that, with a larger quantity of scheduled TB blocks, a probability of incorrect two or more TB blocks is higher. Conversely, with a smaller quantity of scheduled TB blocks, a probability of incorrect two or more TB blocks is lower.

The following describes various possible implementations of this embodiment of this application in detail with reference to Table 8 to Table 26. For ease of understanding, as an example rather than a limitation, in Table 8 to Table 26, an example in which the control information includes the HARQ process index of the first transport block is used for description, and the HARQ process indexes are continuously increasing. It should be understood that, in this embodiment of this application, the control information may alternatively include a plurality of HARQ process indexes, and another association relationship may exist between the HARQ process indexes. This is not limited in this application.

As shown in Table 8, the value range of the quantity L of TBs scheduled by using the control information is [2, 8]. When the quantity L of scheduled TBs is {2, 3, 4, 5}, a supported quantity M of retransmitted TBs may be {1}, or when the quantity L of scheduled TBs is {6, 7, 8}, the supported quantity M of retransmitted TBs may be {1, 2}. When a quantity of TBs scheduled by using the control information is L, the HARQ process index of the first transport block is shown in the table, and remaining L−1 HARQ process indexes may sequentially increase.

In this embodiment of this application, in the value range [2, 8] of the quantity L of scheduled TBs in Table 8, at least one L satisfies that the quantity M of retransmitted TBs belongs to the value range in Table 8, or at least one L is supported to satisfy that the quantity M of retransmitted TBs belongs to the value range in Table 8. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 8], and corresponding quantities Ms of retransmitted TBs are shown in Table 8, a total supported quantity of combinations of quantities of TBs and quantities of retransmitted TBs is 227. In this case, the control information may use 8 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 8
Quantity of TBs, HARQ process index, and combination of the
quantity of TBs and a quantity of retransmitted TBs

| | | | Combination of the |
|---|---|---|---|
| | Value range | M (a quantity of | quantity of TBs and |
| L (a quantity | of a HARQ | retransmitted | the quantity of |
| of TBs) | process index | TBs) | retransmitted TBs |
| 2 | 0-6 | 1 | 14 |
| 3 | 0-5 | | 18 |
| 4 | 0-4 | | 20 |
| 5 | 0-3 | | 20 |
| 6 | 0-2 | 1 or 2 | 63 |
| 7 | 0-1 | | 56 |
| 8 | 0 | | 36 |

| | |
|---|---|
| Total quantity of the | 227 |
| combinations of the quantities | |
| of TBs and the quantities | |
| of retransmitted TBs | |

As shown in Table 9, the value range of the quantity L of TBs scheduled by using the control information is [1, 8]. Compared with that in Table 8, a quantity of TBs in Table 9 may be 1. When the quantity L of TBs is 1, the quantity M of retransmitted TBs may be 1 or 0. In this case, a total supported quantity of combinations of quantities of TBs and quantities of retransmitted TBs is 241, so that the control information may use 8 bits (bit) to indicate a quantity of scheduled TBs, a HARQ process index, and a combination of a quantity of TBs and a quantity of retransmitted TBs.

Similar to Table 8, remaining unsupported quantities Ms of retransmitted blocks may be scheduled and indicated with reference to the conventional technology. Details are not described in the embodiments of this application.

TABLE 9
Another quantity of TBs, HARQ process index, and combination of the
quantity of TBs and a quantity of retransmitted TBs

| | | | Combination of the |
|---|---|---|---|
| | Value range | M (a quantity of | quantity of TBs and |
| L (a quantity | of a HARQ | retransmitted | the quantity of |
| of TBs) | process index | TBs) | retransmitted TBs |
| 1 | 0-7 | 1 | 7 |
| 1 | 0-7 | 0 | 7 |
| 2 | 0-6 | 1 | 14 |
| 3 | 0-5 | | 18 |
| 4 | 0-4 | | 20 |
| 5 | 0-3 | | 20 |
| 6 | 0-2 | 1 or 2 | 63 |
| 7 | 0-1 | | 56 |
| 8 | 0 | | 36 |

| | |
|---|---|
| Total quantity of the | 241 |
| combinations of the quantities | |
| of TBs and the quantities | |
| of retransmitted TBs | |

As shown in Table 10, the value range of the quantity L of TBs scheduled by using the control information is [2, 8]. When the quantity L of scheduled TBs is {2, 3, 4, 5}, a supported quantity M of retransmitted TBs may be {0, 1, L}, or when the quantity L of scheduled TBs is {6, 7, 8}, the supported quantity M of retransmitted TBs may be {0, 1, 2, L}. When a quantity of TBs scheduled by using the control information is L, the HARQ process index of the first transport block is shown in the table, and remaining L−1 HARQ process indexes sequentially increase. Particularly, in Table 10, when the quantity of TBs scheduled by using the control information is L, the HARQ process index of the first transport block may be limited to 0.

In this embodiment of this application, in the value range [2, 8] of the quantity L of scheduled TBs in Table 10, at least one L satisfies that the quantity M of retransmitted TBs belongs to the value range in Table 10, or at least one L is supported to satisfy that the quantity M of retransmitted TBs belongs to the value range in Table 10. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 8], and corresponding quantities Ms of retransmitted TBs are shown in Table 10, a total supported quantity of combinations of quantities of TBs and quantities of retransmitted TBs is 253. In this case, the control information may use 8 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 10
Another quantity of TBs, HARQ process index, and combination of the
quantity of TBs and a quantity of retransmitted TBs

| | | | Combination of the |
|---|---|---|---|
| | Value range | M (a quantity of | quantity of TBs and |
| L (a quantity | of a HARQ | retransmitted | the quantity of |
| of TBs) | process index | TBs) | retransmitted TBs |
| 2 | 0-6 | 0, 1, or L | 28 |
| 3 | 0-5 | | 30 |
| 4 | 0-4 | | 30 |
| 5 | 0-3 | | 28 |
| 6 | 0-2 | 0, 1, 2, or L | 69 |
| 7 | 0 | | 30 |
| 8 | 0 | | 38 |

| | |
|---|---|
| Total quantity of the | 253 |
| combinations of the quantities | |
| of TBs and the quantities | |
| of retransmitted TBs | |

As shown in Table 11, the value range of the quantity L of TBs scheduled by using the control information is [2, 8]. When the quantity L of scheduled TBs is {2, 3, 4, 5}, a supported quantity M of retransmitted TBs may be {0, 1}, or when the quantity L of scheduled TBs is {6, 7, 8}, the supported quantity M of retransmitted TBs may be {0, 1, 2}. When a quantity of TBs scheduled by using the control information is L, the HARQ process index of the first transport block is shown in the table, and remaining L−1 HARQ process indexes sequentially increase. Compared with that in Table 10, in Table 11, when the quantity of TBs scheduled by using the control information is L, the HARQ process index of the first transport block may be 0 or 1.

In this embodiment of this application, in the value range [2, 8] of the quantity L of scheduled TBs in Table 11, at least one L satisfies that the quantity M of retransmitted TBs belongs to the value range in Table 11, or at least one L is supported to satisfy that the quantity M of retransmitted TBs belongs to the value range in Table 11. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 8], and corresponding quantities Ms of retransmitted TBs are shown in Table 11, a total supported quantity of combinations of quantities of TBs and quantities of retransmitted TBs is 255. In this case, the control information may use 8 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 11
Another Quantity of TBs, HARQ process index, and combination of the
quantity of TBs and a quantity of retransmitted TBs

| | | | Combination of the |
|---|---|---|---|
| | Value range | M (a quantity of | quantity of TBs and |
| L (a quantity | of a HARQ | retransmitted | the quantity of |
| of TBs) | process index | TBs) | retransmitted TBs |
| 2 | 0-6 | 0 or 1 | 21 |
| 3 | 0-5 | | 24 |
| 4 | 0-4 | | 25 |
| 5 | 0-3 | | 24 |
| 6 | 0-2 | 0, 1, or 2 | 66 |
| 7 | 0, 1 | | 58 |
| 8 | 0 | | 37 |

| | |
|---|---|
| Total quantity of the | 255 |
| combinations of the quantities | |
| of TBs and the quantities | |
| of retransmitted TBs | |

As shown in Table 12, the value range of the quantity L of TBs scheduled by using the control information is [2, 8]. When the quantity L of scheduled TBs is {2, 3, 4, 5}, a supported quantity M of retransmitted TBs may be {1, L}, or when the quantity L of scheduled TBs is {6, 7, 8}, the supported quantity M of retransmitted TBs may be {1, 2, L}. When a quantity of TBs scheduled by using the control information is L, the HARQ process index of the first transport block is shown in the table, and remaining L−1 HARQ process indexes sequentially increase.

In this embodiment of this application, in the value range [2, 8] of the quantity L of scheduled TBs in Table 12, at least one L satisfies that the quantity M of retransmitted TBs belongs to the value range in Table 12, or at least one L is supported to satisfy that the quantity M of retransmitted TBs belongs to the value range in Table 12. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 8], and corresponding quantities Ms of retransmitted TBs are shown in Table 12, a total supported quantity of combinations of quantities of TBs and quantities of retransmitted TBs is 255. In this case, the control information may use 8 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 12
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 2 | 0-6 | 1 or L | 21 |
| 3 | 0-5 | | 24 |
| 4 | 0-4 | | 25 |
| 5 | 0-3 | | 24 |
| 6 | 0-2 | 1, 2, or L | 66 |
| 7 | 0, 1 | | 58 |
| 8 | 0 | | 37 |

| | |
|---|---|
| Total quantity of the combinations of the quantities | 255 |
| of TBs and the quantities of retransmitted TB s | |

As shown in Table 13, the value range of the quantity L of TBs scheduled by using the control information is [2, 8]. When the quantity L of scheduled TBs is {2, 3, 4, 5}, a supported quantity M of retransmitted TBs may be {0, 1, 2, L}, or when the quantity L of scheduled TBs is {6, 7, 8}, the supported quantity M of retransmitted TBs may be {0, 1, 2, 3, L}. When a quantity of TBs scheduled by using the control information is L, the HARQ process index of the first transport block is shown in the table, and remaining L−1 HARQ process indexes sequentially increase. Particularly, in Table 13, when the quantity of TBs scheduled by using the control information is L, the HARQ process index of the first transport block may be limited to 0.

In this embodiment of this application, in the value range [2, 8] of the quantity L of scheduled TBs in Table 13, at least one L satisfies that the quantity M of retransmitted TBs belongs to the value range in Table 13, or at least one L is supported to satisfy that the quantity M of retransmitted TBs belongs to the value range in Table 13. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 8], and corresponding quantities Ms of retransmitted TBs are shown in Table 13, a total supported quantity of combinations of quantities of TBs and quantities of retransmitted TBs is 492. In this case, the control information may use 9 bits (bit) to indicate a quantity of scheduled TBs, a HARQ process index, and a combination ofa quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 13
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 2 | 0-6 | 0, 1, 2, or L | 28 |
| 3 | 0-5 | | 48 |
| 4 | 0-4 | | 60 |
| 5 | 0-3 | | 68 |
| 6 | 0-2 | 0, 1, 2, 3, or L | 129 |
| 7 | 0 | | 65 |
| 8 | 0 | | 94 |

| | |
|---|---|
| Total quantity of the combinations of the quantities | 492 |
| of TBs and the quantities of retransmitted TBs | |

As shown in Table 14, the value range of the quantity L of TBs scheduled by using the control information is [2, 8]. When the quantity L of scheduled TBs is 12, 3, 4, 5, 6, 7, 81, a supported quantity M of retransmitted TBs may be {0, 1, 2, L}. When a quantity of TBs scheduled by using the control information is L, the HARQ process index of the first transport block is shown in the table, and remaining L−1 HARQ process indexes sequentially increase.

In this embodiment of this application, in the value range [2, 8] of the quantity L of scheduled TBs in Table 14, at least one L satisfies that the quantity M of retransmitted TBs belongs to the value range in Table 14, or at least one L is supported to satisfy that the quantity M of retransmitted TBs belongs to the value range in Table 14. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 8], and corresponding quantities Ms of retransmitted TBs are shown in Table 14, a total supported quantity of combinations of quantities of TBs and quantities of retransmitted TBs is 371. In this case, the control information may use 9 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 14
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 2 | 0-6 | 0, 1, 2, or L | 28 |
| 3 | 0-5 | | 48 |
| 4 | 0-4 | | 60 |
| 5 | 0-3 | | 68 |
| 6 | 0-2 | | 69 |
| 7 | 0-1 | | 60 |
| 8 | 0 | | 38 |

| | |
|---|---|
| Total quantity of the combinations of the quantities | 371 |
| of TBs and the quantities of retransmitted TBs | |

As shown in Table 15, the value range of the quantity L of TBs scheduled by using the control information is [2, 8]. When the quantity L of scheduled TBs is {2, 3, 4, 5, 6, 7, 8}, a supported quantity M of retransmitted TBs may be {0, 1, L}. When a quantity of TBs scheduled by using the control information is L, the HARQ process index of the first transport block is shown in the table, and remaining L−1 HARQ process indexes sequentially increase.

In this embodiment of this application, in the value range [2, 8] of the quantity L of scheduled TBs in Table 15, at least one L satisfies that the quantity M of retransmitted TBs belongs to the value range in Table 15, or at least one L is supported to satisfy that the quantity M of retransmitted TBs belongs to the value range in Table 15. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 8], and corresponding quantities Ms of retransmitted TBs are shown in Table 15, a total supported quantity of combinations of quantities of TBs and quantities of retransmitted TBs is 168. In this case, the control information may use 8 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 15
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 2 | 0-6 | 0, 1, or L | 28 |
| 3 | 0-5 | | 30 |
| 4 | 0-4 | | 30 |
| 5 | 0-3 | | 28 |
| 6 | 0-2 | | 24 |
| 7 | 0-1 | | 18 |
| 8 | 0 | | 10 |

| | |
|---|---|
| Total quantity of the combinations of the quantities | 168 |
| of TBs and the quantities of retransmitted TBs | |

As shown in Table 16, the value range of the quantity L of TBs scheduled by using the control information is [1, 8]. When the quantity L of scheduled TBs is {1, 2, 3, 4, 5, 6, 7, 8}, a value range of a supported quantity M of retransmitted TBs is [0, L]. When a quantity of TBs scheduled by using the control information is L, the HARQ process index of the first transport block is shown in the table, and remaining L−1 HARQ process indexes sequentially increase.

In Table 16, HARQ process indexes corresponding to all TB blocks are consecutive. In this case, a total supported quantity of combinations of quantities of TBs and quantities of retransmitted TBs is 1004. In this case, the control information may use 10 bits (bit) to indicate a quantity of scheduled TBs, a HARQ process index, and a combination of a quantity of TBs and a quantity of retransmitted TBs. This can reduce a quantity of combinations of transport blocks and retransmitted blocks, thereby helping reduce overheads of control information and improve resource utilization.

TABLE 16
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 1 (optionally | 0-7 | 0-L | 16 |
| supported) | | | |
| 2 | 0-6 | | 28 |
| 3 | 0-5 | | 48 |
| 4 | 0-4 | | 80 |
| 5 | 0-3 | | 128 |
| 6 | 0-2 | | 192 |
| 7 | 0 or 1 | | 256 |
| 8 | 0 | | 256 |

| | |
|---|---|
| Total quantity of the combinations of the quantities | 1004 |
| of TBs and the quantities of retransmitted TBs | |

As shown in Table 17, the value range of the quantity L of TBs scheduled by using the control information is [2, 8]. When the quantity L of scheduled TBs is {2, 3, 4, 5, 6, 7, 8}, a supported quantity M of retransmitted TBs may be one of [1, L]. When a quantity of TBs scheduled by using the control information is L, the HARQ process index of the first transport block is shown in the table, and remaining L−1 HARQ process indexes sequentially increase.

In this embodiment of this application, in the value range [2, 8] of the quantity L of scheduled TBs in Table 17, at least one L satisfies that the quantity M of retransmitted TBs belongs to the value range in Table 17, or at least one L is supported to satisfy that the quantity M of retransmitted TBs belongs to the value range in Table 17. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 8], and corresponding quantities Ms of retransmitted TBs are shown in Table 17, a total supported quantity of combinations of quantities of TBs and quantities of retransmitted TBs is 494. In this case, the control information may use 9 bits (bit) to indicate a quantity of scheduled TBs, a HARQ process index, and a combination of a quantity of TBs and a quantity of retransmitted TBs.

It should be understood that, a remaining unsupported quantity 0 of retransmitted blocks may be scheduled and indicated with reference to the conventional technology. Details are not described in the embodiments of this application.

TABLE 17
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 2 | 0-6 | 1-L | 14 |
| 3 | 0-5 | | 24 |
| 4 | 0-4 | | 40 |
| 5 | 0-3 | | 64 |
| 6 | 0-2 | | 96 |
| 7 | 0-1 | | 128 |
| 8 | 0 | | 128 |

| | |
|---|---|
| Total quantity of the combinations of the quantities | 494 |
| of TBs and the quantities of retransmitted TBs | |

As shown in Table 18, the value range of the quantity L of TBs scheduled by using the control information is [2, 8]. When the quantity L of scheduled TBs is {2, 3, 4, 5, 6, 7, 8}, a supported quantity M of retransmitted TBs may be [2, L]. When a quantity of TBs scheduled by using the control information is L, the HARQ process index of the first transport block is shown in the table, and remaining L−1 HARQ process indexes sequentially increase.

In this embodiment of this application, in the value range [2, 8] of the quantity L of scheduled TBs in Table 18, at least one L satisfies that the quantity M of retransmitted TBs belongs to the value range in Table 18, or at least one L is supported to satisfy that the quantity M of retransmitted TBs belongs to the value range in Table 18. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 8], and corresponding quantities Ms of retransmitted TBs are shown in Table 18, a total supported quantity of combinations of quantities of TBs and quantities of retransmitted TBs is 247. In this case, the control information may use 8 bits (bit) to indicate a quantity of scheduled TBs, a HARQ process index, and a combination ofa quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 18
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 2 | 0-6 | 2-L | 7 |
| 3 | 0-5 | | 12 |
| 4 | 0-4 | | 20 |
| 5 | 0-3 | | 32 |
| 6 | 0-2 | | 48 |
| 7 | 0-1 | | 64 |
| 8 | 0 | | 64 |

| | |
|---|---|
| Total quantity of the combinations of the quantities | 247 |
| of TBs and the quantities of retransmitted TBs | |

As shown in Table 19, the value range of the quantity L of TBs scheduled by using the control information is [1, 4]. When the quantity L of scheduled TBs is 11, 2, 3, 41, a value range of a supported quantity M of retransmitted TBs is one of [0, L]. When a quantity of TBs scheduled by using the control information is L, the HARQ process index of the first transport block is shown in the table, and remaining L−1 HARQ process indexes sequentially increase.

In Table 19, HARQ process indexes corresponding to all TB blocks are consecutive. In this case, a total supported quantity of combinations of quantities of TBs and quantities of retransmitted TBs is 52. In this case, the control information may use 6 bits (bit) to indicate a quantity of scheduled TBs, a HARQ process index, and a combination of a quantity of TBs and a quantity of retransmitted TBs. This can reduce a quantity of combinations of transport blocks and retransmitted blocks, thereby helping reduce overheads of control information and improve resource utilization.

TABLE 19
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 1 (optionally | 0-3 | 0-L | 8 |
| supported) | | | |
| 2 | 0-2 | | 12 |
| 3 | 0-1 | | 16 |
| 4 | 0 | | 16 |

| | |
|---|---|
| Total quantity of the combinations of the quantities | 52 |
| of TBs and the quantities of retransmitted TBs | |

As shown in Table 20, the value range of the quantity L of TBs scheduled by using the control information is [1, 4]. When the quantity L of scheduled TBs is 1, a supported quantity M of retransmitted TBs may be {1}, or when the quantity L of scheduled TBs is {2, 3, 4}, a value range of a supported quantity M of retransmitted TBs is [0, 1, L]. When a quantity of TBs scheduled by using the control information is L, the HARQ process index of the first transport block is shown in the table, and remaining L−1 HARQ process indexes sequentially increase.

In this embodiment of this application, in the value range [1, 4] of the quantity L of scheduled TBs in Table 20, at least one L satisfies that the quantity M of retransmitted TBs belongs to the value range in Table 20, or at least one L is supported to satisfy that the quantity M of retransmitted TBs belongs to the value range in Table 20. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [1, 4], and corresponding quantities Ms of retransmitted TBs are shown in Table 20, a total supported quantity of combinations of quantities of TBs and quantities of retransmitted TBs is 32. In this case, the control information may use 5 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 20
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 1 (optionally | 0-3 | 1 | 4 |
| supported) | | | |
| 2 | 0-2 | 0, 1, or L | 12 |
| 3 | 0-1 | | 10 |
| 4 | 0 | | 6 |

| | |
|---|---|
| Total quantity of the combinations of the quantities | 32 |
| of TBs and the quantities of retransmitted TBs | |

As shown in Table 21, the value range of the quantity L of TBs scheduled by using the control information is [1, 4]. When the quantity L of scheduled TBs is {1, 2, 3, 4}, a value range of a supported quantity M of retransmitted TBs is [0, 1, L]. When a quantity of TBs scheduled by using the control information is L, the HARQ process index of the first transport block is shown in the table, and remaining L−1 HARQ process indexes sequentially increase.

In this embodiment of this application, in the value range [1, 4] of the quantity L of scheduled TBs in Table 21, at least one L satisfies that the quantity M of retransmitted TBs belongs to the value range in Table 21, or at least one L is supported to satisfy that the quantity M of retransmitted TBs belongs to the value range in Table 21. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [1, 4], and corresponding quantities Ms of retransmitted TBs are shown in Table 21, a total supported quantity of combinations of quantities of TBs and quantities of retransmitted TBs is 32. In this case, the control information may use 5 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 21
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 1 (optionally | 0-3 | 0, 1, or L | 8 |
| supported) | | | |
| 2 | 0-1 | | 8 |
| 3 | 0-1 | | 10 |
| 4 | 0 | | 6 |

| | |
|---|---|
| Total quantity of the combinations of the quantities | 32 |
| of TBs and the quantities of retransmitted TBs | |

As shown in Table 22, the value range of the quantity L of TBs scheduled by using the control information is [2, 4]. When the quantity L of scheduled TBs is {2, 3, 4}, a value range of a supported quantity M of retransmitted TBs is [0, 1, L]. When a quantity of TBs scheduled by using the control information is L, the HARQ process index of the first transport block is shown in the table, and remaining L−1 HARQ process indexes sequentially increase.

In this embodiment of this application, in the value range [2, 4] of the quantity L of scheduled TBs in Table 22, at least one L satisfies that the quantity M of retransmitted TBs belongs to the value range in Table 22, or at least one L is supported to satisfy that the quantity M of retransmitted TBs belongs to the value range in Table 22. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 4], and corresponding quantities Ms of retransmitted TBs are shown in Table 22, a total supported quantity of combinations of quantities of TBs and quantities of retransmitted TBs is 28. In this case, the control information may use 5 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 22
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 2 | 0-2 | 0, 1, or L | 12 |
| 3 | 0-1 | | 10 |
| 4 | 0 | | 6 |

| | |
|---|---|
| Total quantity of the combinations of the quantities | 28 |
| of TBs and the quantities of retransmitted TBs | |

As shown in Table 23, the value range of the quantity L of TBs scheduled by using the control information is [1, 4]. When the quantity L of scheduled TBs is {1, 2, 3, 4}, a value range of a supported quantity M of retransmitted TBs is [0, 1]. When a quantity of TBs scheduled by using the control information is L, the HARQ process index of the first transport block is shown in the table, and remaining L−1 HARQ process indexes sequentially increase.

In this embodiment of this application, in the value range [1, 4] of the quantity L of scheduled TBs in Table 23, at least one L satisfies that the quantity M of retransmitted TBs belongs to the value range in Table 23, or that at least one L is supported to satisfy that the quantity M of retransmitted TBs belongs to the value range in Table 23. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [1, 4], and corresponding quantities Ms of retransmitted TBs are shown in Table 23, a total supported quantity of combinations of quantities of TBs and quantities of retransmitted TBs is 30. In this case, the control information may use 5 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 23
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 1 (optionally | 0-3 | 0 or 1 | 8 |
| supported) | | | |
| 2 | 0-2 | | 9 |
| 3 | 0-1 | | 8 |
| 4 | 0 | | 5 |

| | |
|---|---|
| Total quantity of the combinations of the quantities | 30 |
| of TBs and the quantities of retransmitted TBs | |

As shown in Table 24, the value range of the quantity L of TBs scheduled by using the control information is [2, 4]. When the quantity L of scheduled TBs is {2, 3, 4}, a supported quantity M of retransmitted TBs may be {1}. When a quantity of TBs scheduled by using the control information is L, the HARQ process index of the first transport block is shown in the table, and remaining L−1 HARQ process indexes sequentially increase.

In this embodiment of this application, in the value range [2, 4] of the quantity L of scheduled TBs in Table 24, at least one L satisfies that the quantity M of retransmitted TBs belongs to the value range in Table 24, or at least one L is supported to satisfy that the quantity M of retransmitted TBs belongs to the value range in Table 24. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 4], and corresponding quantities Ms of retransmitted TBs are shown in Table 24, a total supported quantity of combinations of quantities of TBs and quantities of retransmitted TBs is 16. In this case, the control information may use 4 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 24
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 2 | 0-2 | 1 | 6 |
| 3 | 0-1 | | 6 |
| 4 | 0 | | 4 |

| | |
|---|---|
| Total quantity of the combinations of the quantities | 16 |
| of TBs and the quantities of retransmitted TBs | |

As shown in Table 25, the value range of the quantity L of TBs scheduled by using the control information is [2, 4]. When the quantity L of scheduled TBs is {2, 3, 4}, a value range of a supported quantity M of retransmitted TBs is [1, L]. When a quantity of TBs scheduled by using the control information is L, the HARQ process index of the first transport block is shown in the table, and remaining L−1 HARQ process indexes sequentially increase.

In this embodiment of this application, in the value range [2, 4] of the quantity L of scheduled TBs in Table 25, at least one L satisfies that the quantity M of retransmitted TBs belongs to the value range in Table 25, or at least one L is supported to satisfy that the quantity M of retransmitted TBs belongs to the value range in Table 25. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 4], and corresponding quantities Ms of retransmitted TBs are shown in Table 25, a total supported quantity of combinations of quantities of TBs and quantities of retransmitted TBs is 20. In this case, the control information may use 5 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 25
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 2 | 0-2 | 1-L | 6 |
| 3 | 0-1 | | 8 |
| 4 | 0 | | 8 |

| | |
|---|---|
| Total quantity of the combinations of the quantities | 20 |
| of TBs and the quantities of retransmitted TBs | |

As shown in Table 26, the value range of the quantity L of TBs scheduled by using the control information is [2, 4]. When the quantity L of scheduled TBs is {2, 3, 4}, a value range of a supported quantity M of retransmitted TBs is [2, L]. When a quantity of TBs scheduled by using the control information is L, the HARQ process index of the first transport block is shown in the table, and remaining L−1 HARQ process indexes sequentially increase.

In this embodiment of this application, in the value range [2, 4] of the quantity L of scheduled TBs in Table 26, at least one L satisfies that the quantity M of retransmitted TBs belongs to the value range in Table 26, or at least one L is supported to satisfy that the quantity M of retransmitted TBs belongs to the value range in Table 26. This can reduce a quantity of combinations of transport blocks and retransmitted blocks, and can also limit a quantity of retransmitted TBs in a plurality of TBs scheduled once, thereby helping reduce overheads of control information and improve resource utilization.

In a possible implementation, if the value range of the quantity L of TBs scheduled by using the control information is [2, 4], and corresponding quantities Ms of retransmitted TBs are shown in Table 26, a total supported quantity of combinations of quantities of TBs and quantities of retransmitted TBs is 12. In this case, the control information may use 4 bits (bit) to indicate a quantity of scheduled TBs, a HARQ process index, and a combination of a quantity of TBs and a quantity of retransmitted TBs.

It should be understood that, remaining unsupported quantities Ms of retransmitted blocks may be scheduled and indicated with reference to the conventional technology. Details are not described in the embodiments of this application.

TABLE 26
Another quantity of TBs, HARQ process index, and combination of
the quantity of TBs and a quantity of retransmitted TBs

| | | M (a quantity | Combination of the |
|---|---|---|---|
| | | of | quantity of TBs and |
| L (a quantity | Value range of a HARQ process | retransmitted | the quantity of |
| of TBs) | index | TBs) | retransmitted TBs |
| 2 | 0-2 | 2-L | 3 |
| 3 | 0-1 | | 4 |
| 4 | 0 | | 5 |

| | |
|---|---|
| Total quantity of the combinations of the quantities | 12 |
| of TBs and the quantities of retransmitted TBs | |

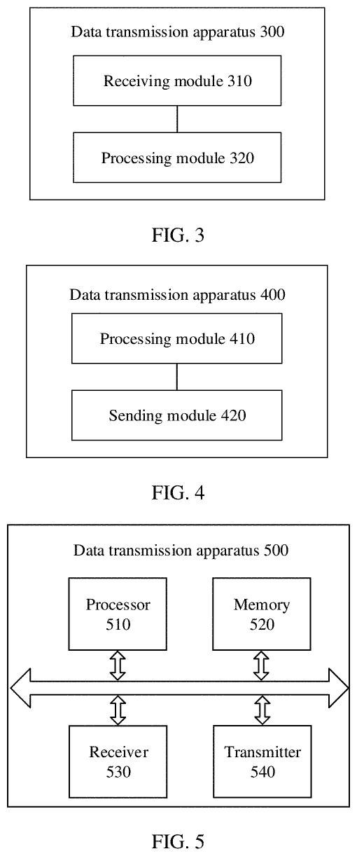

FIG. 3 is a schematic block diagram of an apparatus 300 according to an embodiment of this application. It should be understood that the apparatus 300 is merely an example. The apparatus in this embodiment of this application may further include another module or unit, or include a module having a function similar to that of each module in FIG. 3, or include not all modules in FIG. 3.

A receiving module 310 is configured to receive control information sent by a second communications device, where the control information is used to schedule L transport blocks, and L is a positive integer greater than 1.

M transport blocks in the L transport blocks scheduled by using the control information are retransmitted, M is a positive integer not greater than L, M is a value in a first value set, and the first value set is a predefined value set or the first value set is a value set indicated by the second communications device, or

H transport blocks in the L transport blocks scheduled by using the control information are retransmitted, H is an integer, H is a value in a second value set associated with the quantity L of transport blocks, and the second value set is a predefined value set or the second value set is a value set indicated by the second communications device, or the control information indicates that K transport blocks in the L transport blocks are retransmitted, K is an integer whose value range is {0, 1, 2, . . . , L}, each of the L transport blocks corresponds to one hybrid automatic repeat request (HARQ) process index, and L HARQ process indexes corresponding to the L transport blocks are consecutive.

A processing module 320 is configured to determine, based on the control information, whether the transport blocks scheduled by using the control information are newly transmitted or retransmitted, and send or receive the transport blocks based on the scheduling with the control information.

Optionally, the first value set is {1}, {1, 2}, {0, 1}, {0, 1, 2}, or {0, 1, 2, 3}, or the first value set is {0, 1, L} or {0, 1, 2, L}, or the first value set is {1, 2, . . . , T}, or the first value set is {0, 1, 2, . . . , T}, or the first value set is {1, 2, . . . , T−1}, and T is a positive integer indicated by the second communications device.

Optionally, when L belongs to a first transport block quantity set, the second value set includes H1 values, or when L belongs to a second transport block quantity set, the second value set includes H2 values, and H1 is a positive integer, H2 is a positive integer, H1 is not equal to H2, and the first transport block quantity set and the second transport block quantity set are different sets.

Optionally, when the first transport block quantity set is {2, 3, 4, 5}, the second value set is {1}, {0, 1}, {0, 1, L}, {1, L}, or {0, 1, 2, L}, and/or when the second transport block quantity set is {6, 7, 8}, the second value set is {1, 2}, {0, 1, 2}, {0, 1, 2, L}, {1, 2, L}, or {0, 1, 2, 3, L}.

Optionally, when L=2, L=3, L=4, or L=5, the second value set is {1}, {0, 1}, {0, 1, L}, {1, L}, or {0, 1, 2, L}, and/or when L=6, L=7, or L=8, the second value set is {1, 2}, {0, 1, 2}, {0, 1, 2, L}, {1, 2, L}, or {0, 1, 2, 3, L}.

Optionally, the control information includes a first field, at least one of bit states of the first field indicates that the control information is used to schedule a single transport block (TB), and at least one of bit states of the first field indicates that the control information is used for first scheduling, where the first scheduling indicates that the control information is used to schedule a plurality of transport blocks, and the control information can be used to schedule a part of newly transmitted TBs and a part of retransmitted TBs.

Optionally, the first field indicates that the control information is used to schedule a single newly transmitted TB, and the first field indicates a hybrid automatic repeat request (HARQ) process index of the TB, or the first field indicates that the control information is used to schedule a single retransmitted TB, and the first field indicates a hybrid automatic repeat request (HARQ) process index of the TB.

Optionally, at least a first transport block in a plurality of transport blocks scheduled by using the control information is retransmitted, or an L^{th} transport block in a plurality of transport blocks scheduled by using the control information is retransmitted, or at least a first transport block in a plurality of transport blocks scheduled by using the control information is retransmitted, and an L^{th} transport block in the plurality of transport blocks scheduled by using the control information is retransmitted.

Optionally, a HARQ process index of another transport block different from the first transport block in the L transport blocks scheduled by using the control information is determined based on a HARQ process index of the first transport block, and/or each of the L transport blocks scheduled by using the control information corresponds to one HARQ process index, and the L HARQ process indexes corresponding to the L transport blocks are consecutive.

Optionally, when the quantity of the transport blocks scheduled by using the control information is greater than X, the HARQ process index of the first transport block in the plurality of transport blocks scheduled by using the control information is 0, or the HARQ process index of the first transport block is a preset value, or the HARQ process index of the first transport block is a fixed value, where X is a preset positive integer, or X is a configured positive integer.

FIG. 4 is a schematic block diagram of an apparatus 400 according to an embodiment of this application. It should be understood that the apparatus 400 is merely an example. The apparatus in this embodiment of this application may further include another module or unit, or include a module having a function similar to that of each module in FIG. 4, or include not all modules in FIG. 4.

A processing module 410 is configured to generate control information. The control information is used to schedule L transport blocks, and L is a positive integer greater than 1.

M transport blocks in the L transport blocks scheduled by using the control information are retransmitted, M is a positive integer not greater than L, M is a value in a first value set, and the first value set is a predefined value set or the first value set is a value set indicated by the second communications device, or

H transport blocks in the L transport blocks scheduled by using the control information are retransmitted, H is an integer, H is a value in a second value set associated with the quantity L of transport blocks, and the second value set is a predefined value set or the second value set is a value set indicated by the second communications device, or

the control information indicates that K transport blocks in the L transport blocks are retransmitted, K is an integer whose value range is {0, 1, 2, . . . , L}, each of the L transport blocks corresponds to one hybrid automatic repeat request (HARQ) process index, and L HARQ process indexes corresponding to the L transport blocks are consecutive.

The sending module 420 is configured to send the control information to a first communications device.

Optionally, the first value set is {1}, {1, 2}, {0, 1}, {0, 1, 2}, or {0, 1, 2, 3}, or the first value set is {0, 1, L} or {0, 1, 2, L}, or the first value set is {1, 2, . . . , T}, or the first value set is {0, 1, 2, . . . , T}, or the first value set is {1, 2, . . . , T−1}, and T is a positive integer indicated by the second communications device.

Optionally, when L belongs to a first transport block quantity set, the second value set includes H1 values, or when L belongs to a second transport block quantity set, the second value set includes H2 values, and H1 is a positive integer, H2 is a positive integer, H1 is not equal to H2, and the first transport block quantity set and the second transport block quantity set are different sets.

Optionally, when the first transport block quantity set is {2, 3, 4, 5}, the second value set is {1}, {0, 1}, {0, 1, L}, {1, L}, or {0, 1, 2, L}, and/or when the second transport block quantity set is {6, 7, 8}, the second value set is {1, 2}, {0, 1, 2}, {0, 1, 2, L}, {1, 2, L}, or {0, 1, 2, 3, L}.

Optionally, when L=2, L=3, L=4, or L=5, the second value set is {1}, {0, 1}, {0, 1, L}, {1, L}, or {0, 1, 2, L}, and/or when L=6, L=7, or L=8, the second value set is {1, 2}, {0, 1, 2}, {0, 1, 2, L}, {1, 2, L}, or {0, 1, 2, 3, L}.

Optionally, the control information includes a first field, at least one of bit states of the first field indicates that the control information is used to schedule a single transport block (TB), and at least one of bit states of the first field indicates that the control information is used for first scheduling, where the first scheduling indicates that the control information is used to schedule a plurality of transport blocks, and the control information can be used to schedule a part of newly transmitted TBs and a part of retransmitted TBs.

Optionally, the first field indicates that the control information is used to schedule a single newly transmitted TB, and the first field indicates a hybrid automatic repeat request (HARQ) process index of the TB, or the first field indicates that the control information is used to schedule a single retransmitted TB, and the first field indicates a hybrid automatic repeat request (HARQ) process index of the TB.

Optionally, at least a first transport block in a plurality of transport blocks scheduled by using the control information is retransmitted, or an L^{th} transport block in a plurality of transport blocks scheduled by using the control information is retransmitted, or at least a first transport block in a plurality of transport blocks scheduled by using the control information is retransmitted, and an L^{th} transport block in the plurality of transport blocks scheduled by using the control information is retransmitted.

Optionally, a HARQ process index of another transport block different from the first transport block in the L transport blocks scheduled by using the control information is determined based on a HARQ process index of the first transport block, and/or each of the L transport blocks scheduled by using the control information corresponds to one HARQ process index, and the L HARQ process indexes corresponding to the L transport blocks are consecutive.

Optionally, when the quantity of the transport blocks scheduled by using the control information is greater than X, the HARQ process index of the first transport block in the plurality of transport blocks scheduled by using the control information is 0, or the HARQ process index of the first transport block is a preset value, or the HARQ process index of the first transport block is a fixed value, where X is a preset positive integer, or X is a configured positive integer.

FIG. 5 is a schematic structural diagram of a communications apparatus 500 according to an embodiment of this application. It should be understood that the communications apparatus 500 shown in FIG. 5 is merely an example. The communications apparatus in this embodiment of this application may further include another module or unit, or a module with a function similar to that of each module in FIG. 5.

The communications apparatus 500 may include one or more processors 510, one or more memories 520, a receiver 530, and a transmitter 540. The receiver 530 and the transmitter 540 may be integrated together to obtain a transceiver. The memory 520 is configured to store program code executed by the processor 510. The memory 520 may be integrated into the processor 510, or the processor 510 is coupled to the one or more memories 520, to invoke instructions in the memory 520.

In an embodiment, the receiver 530 may be configured to implement operations or steps that can be implemented by the receiving module 310 in FIG. 3, and the processor 510 may be configured to implement operations or steps that can be implemented by the processing module 320 in FIG. 3.

In another embodiment, the processor 510 may be configured to implement operations or steps that can be implemented by the processing module 410 in FIG. 4, and the transmitter 540 may be configured to implement operations or steps that can be implemented by the sending module 420 in FIG. 4.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiments are merely examples. For example, the unit division is merely logical function division and may be other division during actual implementation. For example, a plurality of units or components may be combined or integrated into another system, or some features may be ignored or not performed. In addition, the displayed or discussed mutual couplings or direct couplings or communications connections may be implemented through some interfaces. The indirect couplings or communications connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the method described in the embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A data processing method, comprising:
receiving, by a first communications device, control information sent by a second communications device, wherein the control information is associated with scheduling L transport blocks, and L is a positive integer greater than 1, wherein at least one of:
M transport blocks in the L transport blocks scheduled by using the control information are retransmitted, wherein M is a positive integer not greater than L, M is a value in a first value set, and the first value set is a predefined value set or the first value set is a value set indicated by the second communications device; or
H transport blocks in the L transport blocks scheduled by using the control information are retransmitted, wherein H is an integer, H is a value in a second value set associated with the quantity L of transport blocks, and the second value set is a predefined value set or the second value set is a value set indicated by the second communications device; or
the control information indicates that K transport blocks in the L transport blocks are retransmitted, K is an integer whose value range is {0, 1, 2, . . . , L}, each of the L transport blocks corresponds to one hybrid automatic repeat request (HARQ) process index, and L HARQ process indexes corresponding to the L transport blocks are consecutive;
determining, by the first communications device based on the control information, whether the transport blocks scheduled by using the control information are newly transmitted or retransmitted, and
communicating, by sending or receiving, the transport blocks based on the scheduling and the control information.

2. The method according to claim 1, wherein at least one of:
the first value set is {1}, {1, 2}, {0, 1}, {0, 1, 2}, or {0, 1, 2, 3}; or
the first value set is {0, 1, L} or {0, 1, 2, L}; or
the first value set is {1, 2, . . . , T}; or
the first value set is {0, 1, 2, . . . , T}; or
the first value set is {1, 2, . . . , T−1}; and
wherein T is a positive integer indicated by the second communications device.

3. The method according to claim 1, wherein at least one of
the second value set comprises H1 values and L belongs to a first transport block quantity set; or
the second value set comprises H2 values and L belongs to a second transport block quantity set; and
wherein H1 is a positive integer, H2 is a positive integer, H1 is not equal to H2, and wherein the first transport block quantity set and the second transport block quantity set are different sets.

4. The method according to claim 3, wherein at least one of:
the second value set is at least one of {1}, {0, 1}, {0, 1, L}, {1, L}, or {0, 1, 2, L}, and wherein the first transport block quantity set is {2, 3, 4, 5}; or
the second value set is at least one of {1, 2}, {0, 1, 2}, {0, 1, 2, L}, {1, 2, L}, or {0, 1, 2, 3, L} and wherein the second transport block quantity set is {6, 7, 8}.

5. The method according to claim 1, wherein at least one of:
the second value set is at least one of {1}, {0, 1}, {0, 1, L}, {1, L}, or {0, 1, 2, L}, and wherein L=2, L=3, L=4, or L=5; or
the second value set is at least one of {1, 2}, {0, 1, 2}, {0, 1, 2, L}, {1, 2, L}, or {0, 1, 2, 3, L}, and wherein L=6, L=7, or L=8.

6. A data processing method, comprising:
generating, by a second communications device, control information, wherein the control information is associated with scheduling L transport blocks, and L is a positive integer greater than 1, wherein at least one of:
M transport blocks in the L transport blocks scheduled by using the control information are retransmitted, M is a positive integer not greater than L, M is a value in a first value set, and wherein the first value set is a predefined value set or the first value set is a value set indicated by the second communications device; or
H transport blocks in the L transport blocks scheduled by using the control information are retransmitted, H is an integer, H is a value in a second value set associated with the quantity L of transport blocks, and wherein the second value set is a predefined value set or the second value set is a value set indicated by the second communications device; or
the control information indicates that K transport blocks in the L transport blocks are retransmitted, K is an integer whose value range is {0, 1, 2, . . . , L}, each of the L transport blocks corresponds to one hybrid automatic repeat request (HARQ) process index, and wherein L HARQ process indexes corresponding to the L transport blocks are consecutive; and
sending, by the second communications device, the control information to a first communications device.

7. The method according to claim 6, wherein at least one of:
the first value set is {1}, {1, 2}, {0, 1}, {0, 1, 2}, or {0, 1, 2, 3}; or
the first value set is {0, 1, L} or {0, 1, 2, L}; or
the first value set is {1, 2, . . . , T}; or
the first value set is {0, 1, 2, . . . , T}; or
the first value set is {1, 2, . . . , T−1}; and
wherein T is a positive integer indicated by the second communications device.

8. The method according to claim 6, wherein at least one of:
the second value set comprises H1 values and L belongs to a first transport block quantity set; or
the second value set comprises H2 values, and L belongs to a second transport block quantity set; and
wherein H1 is a positive integer, H2 is a positive integer, H1 is not equal to H2, and wherein the first transport block quantity set and the second transport block quantity set are different sets.

9. The method according to claim 8, wherein at least one of:
the second value set is at least one of {1}, {0, 1}, {0, 1, L}, {1, L}, or {0, 1, 2, L} and wherein the first transport block quantity set is {2, 3, 4, 5}; or
the second value set is at least one of {1, 2}, {0, 1, 2}, {0, 1, 2, L}, {1, 2, L}, or {0, 1, 2, 3, L} and wherein the second transport block quantity set is {6, 7, 8}.

10. The method according to claim 6, wherein at least one of:
the second value set is at least one of {1}, {0, 1}, {0, 1, L}, {1, L}, or {0, 1, 2, L}, and wherein L=2, L=3, L=4, or L=5; or
the second value set is at least one of {1, 2}, {0, 1, 2}, {0, 1, 2, L}, {1, 2, L}, or {0, 1, 2, 3, L}, and wherein L=6, L=7, or L=8.

11. A first communications device, comprising:
at least one processor; and
one or more non-transitory memories coupled to the at least one processor and storing programming instructions for execution by the at least one processor, the programming instructions including instructions to:
receive control information sent by a second communications device, wherein the control information is associated with scheduling L transport blocks, and L is a positive integer greater than 1, wherein at least one of:
M transport blocks in the L transport blocks scheduled by using the control information are retransmitted, M is a positive integer not greater than L, M is a value in a first value set, and wherein the first value set is a predefined value set or the first value set is a value set indicated by the second communications device; or
H transport blocks in the L transport blocks scheduled by using the control information are retransmitted, H is an integer, H is a value in a second value set associated with the quantity L of transport blocks, and wherein the second value set is a predefined value set or the second value set is a value set indicated by the second communications device; or
the control information indicates that K transport blocks in the L transport blocks are retransmitted, K is an integer whose value range is {0, 1, 2, . . . , L}, each of the L transport blocks corresponds to one hybrid automatic repeat request (HARQ) process index, and wherein L HARQ process indexes corresponding to the L transport blocks are consecutive;
determine, based on the control information, whether the transport blocks scheduled by using the control information are newly transmitted or retransmitted and
communicate, by sending or receiving the transport blocks based on the scheduling and the control information.

12. The device according to claim 11, wherein at least one of:
the first value set is {1}, {1, 2}, {0, 1}, {0, 1, 2}, or {0, 1, 2, 3}; or
the first value set is {0, 1, L} or {0, 1, 2, L}; or
the first value set is {1, 2, . . . , T}; or
the first value set is {0, 1, 2, . . . , T}; or
the first value set is {1, 2, . . . , T−1}; and
wherein T is a positive integer indicated by the second communications device.

13. The device according to claim 11, wherein at least one of:
the second value set comprises H1 values and wherein L belongs to a first transport block quantity set; or
the second value set comprises H2 values and wherein L belongs to a second transport block quantity set; and
wherein H1 is a positive integer, H2 is a positive integer, H1 is not equal to H2, and the first transport block quantity set and the second transport block quantity set are different sets.

14. The device according to claim 13, wherein at least one of:
the second value set is at least one of {1}, {0, 1}, {0, 1, L}, {1, L}, or {0, 1, 2, L} and wherein the first transport block quantity set is {2, 3, 4, 5}; or
the second value set is at least one of {1, 2}, {0, 1, 2}, {0, 1, 2, L}, {1, 2, L}, or {0, 1, 2, 3, L} and wherein the second transport block quantity set is {6, 7, 8}.

15. The device according to claim 11, wherein at least one of:
the second value set is at least one of {1}, {0, 1}, {0, 1, L}, {1, L}, or {0, 1, 2, L}, and wherein L=2, L=3, L=4, or L=5; or
the second value set is at least one of {1, 2}, {0, 1, 2}, {0, 1, 2, L}, {1, 2, L}, or {0, 1, 2, 3, L}, and wherein L=6, L=7, or L=8.

16. A second communications device, comprising:
at least one processor; and
one or more non-transitory memories coupled to the at least one processor and storing programming instructions for execution by the at least one processor, the programming instructions including instructions to:
generate control information, wherein the control information is associated with scheduling L transport blocks, and L is a positive integer greater than 1, wherein at least one of:
M transport blocks in the L transport blocks scheduled by using the control information are retransmitted, M is a positive integer not greater than L, M is a value in a first value set, and wherein the first value set is a predefined value set or the first value set is a value set indicated by the second communications device; or
H transport blocks in the L transport blocks scheduled by using the control information are retransmitted, H is an integer, H is a value in a second value set associated with the quantity L of transport blocks, and wherein the second value set is a predefined value set or the second value set is a value set indicated by the second communications device; or
the control information indicates that K transport blocks in the L transport blocks are retransmitted, K is an integer whose value range is {0, 1, 2, . . . , L}, each of the L transport blocks corresponds to one hybrid automatic repeat request (HARQ) process index, and wherein L HARQ process indexes corresponding to the L transport blocks are consecutive; and
send the control information to a first communications device.

17. The device according to claim 16, wherein at least one of:
the first value set is {1}, {1, 2}, {0, 1}, {0, 1, 2}, or {0, 1, 2, 3}; or
the first value set is {0, 1, L} or {0, 1, 2, L}; or
the first value set is {1, 2, . . . , T}; or
the first value set is {0, 1, 2, . . . , T}; or
the first value set is {1, 2, . . . , T−1}; and
wherein T is a positive integer indicated by the second communications device.

18. The device according to claim 16, wherein at least one of:
the second value set comprises H1 values and wherein L belongs to a first transport block quantity set; or
the second value set comprises H2 values and wherein L belongs to a second transport block quantity set; and
wherein H1 is a positive integer, H2 is a positive integer, H1 is not equal to H2, and wherein the first transport block quantity set and the second transport block quantity set are different sets.

19. The device according to claim 18, wherein at least one of:
the second value set is at least one of {1}, {0, 1}, {0, 1, L}, {1, L}, or {0, 1, 2, L} and wherein the first transport block quantity set is {2, 3, 4, 5}; or
the second value set is at least one of {1, 2}, {0, 1, 2}, {0, 1, 2, L}, {1, 2, L}, or {0, 1, 2, 3, L}, and wherein the second transport block quantity set is {6, 7, 8}.

20. The device according to claim 16, wherein at least one of:
the second value set is at least one of {1}, {0, 1}, {0, 1, L}, {1, L}, or {0, 1, 2, L} and wherein L=2, L=3, L=4, or L=5; or
the second value set is at least one of {1, 2}, {0, 1, 2}, {0, 1, 2, L}, {1, 2, L}, or {0, 1, 2, 3, L} and wherein L=6, L=7, or L=8.
